(19) United States
(12) Patent Application Publication
(10) Pub. No.: US 2024/0328017 A1
(43) Pub. Date: Oct. 3, 2024

(54) CONTROLLER

(71) Applicant: HONDA MOTOR CO., LTD., TOKYO (JP)

(72) Inventors: Takumi KAWANO, WAKO-SHI (JP); Tomohiro TAKAYANAGI, WAKO-SHI (JP)

(21) Appl. No.: 18/588,495

(22) Filed: Feb. 27, 2024

(30) Foreign Application Priority Data
Mar. 29, 2023 (JP) 2023-053172

(51) Int. Cl. C25B 15/023; C25B 1/04; C25B 9/23; C25B 15/08

(52) U.S. Cl. CPC C25B 15/023; C25B 1/04; C25B 9/23; C25B 15/08

(57) ABSTRACT

A controller of an electrolysis system in the present disclosure changes a current value to be specified for a first power supply device according to the pressure detected by a first pressure sensor provided on an oxygen supply passage between a pressure control valve and a water electrolysis stack.

### CROSS-REFERENCE TO RELATED APPLICATIONS

This application is based upon and claims the benefit of priority from Japanese Patent Application No. 2023-053172 filed on Mar. 29, 2023, the contents of which are incorporated herein by reference.

### BACKGROUND OF THE INVENTION

### Field of the Invention

The present invention relates to a controller for an electrolysis system.

### Description of the Related Art

In recent years, there has been research and development on electrolysis systems including water electrolysis stacks that contribute to energy efficiency to ensure that more people can have access to affordable, reliable, sustainable, and modern energy.

A water electrolysis stack carries out electrolysis of water and produces a hydrogen gas and an oxygen gas. JP 2010-059503 A discloses a method for activating a water electrolysis stack. This activating method sets an upper limit for the stack voltage and incrementally increases electric current to a rated value while monitoring the stack voltage and the electric current flowing through the water electrolysis stack.

### SUMMARY OF THE INVENTION

Recently, it has been desired to increase the amount (generation rate) of gas generated in a stack at the activation of the stack.

An object of the present invention is to solve the aforementioned problems.

An aspect of the present invention is a controller for controlling an electrolysis system comprising: a water electrolysis stack that is provided with a membrane electrode assembly including an electrolyte membrane and a pair of electrodes that sandwich the electrolyte membrane, and electrolyzes water supplied to one of the pair of electrodes; a pressure control valve that is provided on a flow path through which oxygen gas acquired by the electrolysis flows and adjusts gas pressure in the flow path to a predetermined pressure; and a first power supply device that applies voltage to the pair of electrodes in a manner so that current having a specified current value flows between the pair of electrodes, wherein the controller comprises one or more processors that execute computer-executable instructions, when receiving the instructions to activate the water electrolysis stack, the controller changes the current value specified for the first power supply device according to pressure detected by a first pressure sensor provided on the flow path between the pressure control valve and the water electrolysis stack.

According to the above aspect, the amount (generation rate) of gas generated in the stack can be increased without increasing the size of the electrode area or the number of the membrane-electrode assembly (number of cells).

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram illustrating an electrolysis system according to an embodiment.

FIG. 2 is a diagram showing a time chart concerning an activation process of a controller.

FIG. 3 is a diagram showing the relationship between pressure and electric current.

FIG. 4 is a schematic diagram showing an electrolysis system according to a modified example.

### DETAILED DESCRIPTION OF THE INVENTION

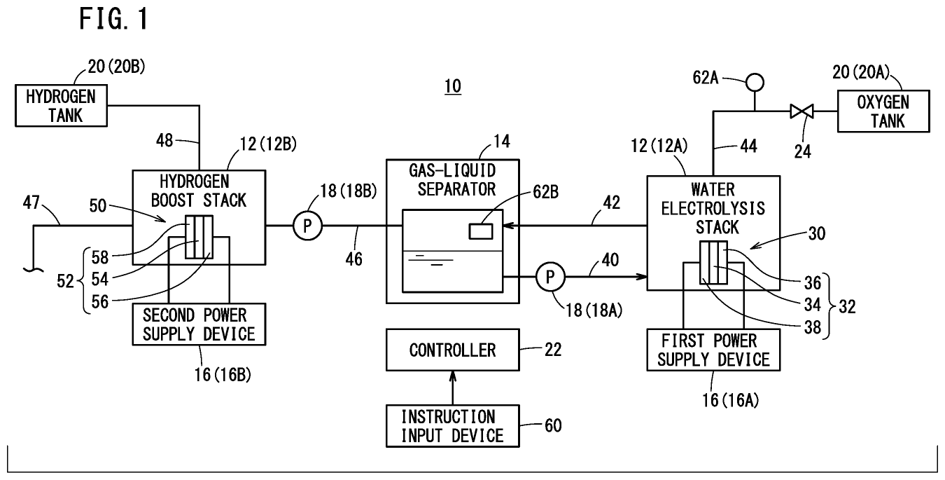

FIG. 1 is a schematic diagram illustrating an electrolysis system 10 according to an embodiment. The electrolysis system 10 has two stacks 12, a gas-liquid separator 14, two power supply devices 16, two fluid suppliers 18, two tanks 20, and a controller 22.

One of the two stacks 12 is a water electrolysis stack 12A for electrolyzing water. The other of the two stacks 12 is a hydrogen boost stack 12B that boosts the pressure of hydrogen gas.

One of the two power supply devices 16 is a first power supply device 16A that is connected to the water electrolysis stack 12A. The other of the two power supply devices 16 is a second power supply device 16B that is connected to the hydrogen boost stack 12B.

One of the two fluid suppliers 18 is a water supplier 18A that supplies water to the water electrolysis stack 12A. The other of the two fluid suppliers 18 is a hydrogen supplier 18B that supplies hydrogen gas to the hydrogen boost stack 12B.

One of the two tanks 20 is an oxygen tank 20A that stores oxygen gas generated in the water electrolysis stack 12A. The other of the two tanks 20 is a hydrogen tank 20B that stores hydrogen gas generated in the hydrogen boost stack 12B.

The water electrolysis stack 12A has a plurality of unit cells for electrolyzing water. Each unit cell 30 has the same configuration. FIG. 1 shows only one unit cell 30. The unit cell has a membrane electrode assembly 32. The membrane electrode assembly 32 includes an electrolyte membrane 34, an anode electrode 36, and a cathode electrode 38. The electrolyte membrane 34 is, for example, an anion exchange membrane capable of transporting hydroxide ions OH⁻. The electrolyte membrane 34 is sandwiched between the anode electrode 36 and the cathode electrode 38.

In the unit cell 30, water is electrolyzed based on electric current supplied to the membrane electrode assembly 32. Water is supplied to the cathode electrode 38 of each unit cell 30 via a water supply path 40. The cathode electrode 38 decomposes part of water into hydrogen ions H⁺ and hydroxide ions OH⁻ by electrochemical reaction.

The hydrogen ions H⁺ receive electrons at the cathode electrode 38 and become hydrogen gas. The hydrogen gas obtained at each unit cell 30 flows out to a water discharge path 42 together with the water that has not been electrolyzed.

The hydroxide ions OH-migrate to the anode electrode 36 through the electrolyte membrane 34. The hydroxide ions OH⁻ that have migrated to the anode electrode 36 emit electrons from the anode electrode 36. When the hydroxide ions OH-release electrons, oxygen gas and water are generated. The oxygen gas generated at the anode electrode 36 of each unit cell 30 flows to the oxygen tank 20A via a flow path communicating with the anode electrode 36. The flow path communicating with the anode electrode 36 includes an oxygen supply passage 44 connecting the water electrolysis stack 12A and the oxygen tank 20A.

When water is electrolyzed in the unit cell 30, a differential pressure is generated between both sides of the electrolyte membrane 34. Due to this differential pressure, most of the water generated at the anode electrode 36 is returned to the cathode electrode 38 through the electrolyte membrane 34. In addition, crosstalk is reduced, in which hydrogen gas generated at the cathode electrode 38 moves to the anode electrode 36 through the electrolyte membrane 34 due to the differential pressure generated between both sides of the electrolyte membrane 34.

A pressure control valve 24 is provided on the oxygen supply passage 44. The pressure control valve 24 is a control valve that regulates the gas pressure in the oxygen supply passage 44 to a predetermined pressure RP. As examples of the pressure control valve 24, there can be raised a solenoid valve, a back pressure valve, or the like the opening degree of which can be adjusted. The pressure control valve 24 is set lower than the target pressure. The target pressure is determined based on the allowable water content in the oxygen gas generated in the water electrolysis stack 12A. For example, when the target pressure is 30 MPa, the pressure (predetermined pressure RP) set for the pressure control valve 24 is 20 MPa. The pressure control valve 24 is provided on the oxygen supply passage 44, whereby the generation rate of oxygen gas in the oxygen supply passage 44 can be increased.

The hydrogen boost stack 12B has a plurality of unit cells 50 that electrolyze hydrogen gas. Each unit cell 50 has the same configuration. FIG. 1 shows only one unit cell 50. The unit cell 50 has a membrane electrode assembly 52. The membrane electrode assembly 52 includes an electrolyte membrane 54, an anode electrode 56, and a cathode electrode 58. The electrolyte membrane 54 is, for example, a proton exchange membrane capable of transporting protons H⁺. The electrolyte membrane 54 is sandwiched between the anode electrode 56 and the cathode electrode 58.

In the unit cell 50, hydrogen gas is electrolyzed based on the electric current supplied to the membrane electrode assembly 52. Hydrogen gas is supplied to the anode electrode 56 of each unit cell 50 through the hydrogen supply path 46.

At the anode electrode 56, part of the hydrogen gas is converted to protons H⁺. Hydrogen gas that has not been converted to protons H⁺ flows out to the hydrogen discharge path 47. The hydrogen gas that has flowed out to the hydrogen discharge path 47 may be returned to the gas-liquid separator 14.

The proton H⁺ generated at the anode electrode 56 moves toward the cathode electrode 58 due to the potential difference between the anode electrode 56 and the cathode electrode 58. The proton H⁺ transfer proceeds against the pressure difference between both sides of the electrolyte membrane 54. The protons H⁺ accept electrons at the cathode electrode 58 and becomes hydrogen gas. The hydrogen gas generated at the cathode electrode 58 of each unit cell 50 flows to the hydrogen tank 20B via a flow path communicating with the cathode electrode 58. The flow path communicating with the cathode electrode 58 includes a hydrogen supply path 48 connecting the hydrogen boost stack 12B and the hydrogen tank 20B.

The hydrogen supply passage 48 may be provided with the above-described pressure control valve 24. In this case, the pressure of the pressure control valve 24 is set lower than the target pressure determined based on the allowable water content in the hydrogen gas boosted by the hydrogen boost stack 12B. When the pressure control valve 24 is provided on the hydrogen supply passage 48, the boosting rate of hydrogen gas in the hydrogen supply passage 48 can be increased.

The gas-liquid separator 14 separates the hydrogen-containing water supplied from the water electrolysis stack 12A through the water discharge path 42 into liquid water and hydrogen gas and stores them. The liquid water stored in the gas-liquid separator 14 is supplied to the water electrolysis stack 12A through the water supply path 40. In other words, the gas-liquid separator 14 is a source of liquid water supplied to the water electrolysis stack 12A. The hydrogen gas stored by the gas-liquid separator 14 is supplied to the hydrogen boost stack 12B through the hydrogen supply path 46. In other words, the gas-liquid separator 14 is a source of hydrogen gas supplied to the hydrogen boost stack 12B.

The first power supply device 16A is connected to the anode electrode 36 and the cathode electrode 38. The first power supply device 16A is capable of adjusting the current flowing between the anode electrode 36 and the cathode electrode 38. The first power supply device 16A applies voltage to the anode electrode 36 and the cathode electrode 38 in a manner so that the current having a current value specified by the controller 22 flows between the anode electrode 36 and the cathode electrode 38.

The second power supply device 16B is connected to the anode electrode 56 and the cathode electrode 58. The second power supply device 16B is capable of adjusting the current flowing between the anode electrode 56 and the cathode electrode 58. The second power supply device 16B applies voltage to the anode electrode 56 and the cathode electrode 58 in a manner so that the current having a current value specified by the controller 22 flows between the anode electrode 56 and the cathode electrode 58.

The water supplier 18A is a device that supplies water to the water electrolysis stack 12A. The water supplier 18A is provided on the water supply path 40. The water supplier 18A operates under the control of the controller 22. The water supplier 18A supplies water stored in the gas-liquid separator 14 to the water electrolysis stack 12A via the water supply path 40. The water supplier 18A may be a pump or a valve. FIG. 1 shows an example where the water supplier 18A is a pump.

The hydrogen supplier 18B is a device that supplies hydrogen gas to the hydrogen boost stack 12B. The hydrogen supplier 18B is provided on the hydrogen supply path 46. The hydrogen supplier 18B operates under the control of the controller 22. The hydrogen supplier 18B supplies the hydrogen gas stored in the gas-liquid separator 14 to the hydrogen boost stack 12B via the hydrogen supply path 46. The hydrogen supplier 18B may be a pump or a valve. FIG. 1 shows an example where the hydrogen supplier 18B is a pump.

The controller 22 is a computer that manages the electrolysis system 10. An instruction input device 60 is connected to the controller 22. The instruction input device 60 is a device that can input at least a system activation instruction or a system stop instruction. The instruction input device 60 may be a lever-type on-off switch.

In addition, a plurality of sensors are connected to the controller 22. The sensors connected to the controller 22 include a first voltage sensor and a first current sensor. The first voltage sensor and the first current sensor are provided at the first power supply device 16A. The first voltage sensor detects a voltage value of the voltage applied between the anode electrode 36 and the cathode electrode 38. The first current sensor detects a current value of the current flowing between the anode electrode 36 and the cathode electrode 38.

The sensors connected to the controller 22 include a second voltage sensor and a second current sensor. The second voltage sensor and the second current sensor are provided at the second power supply device 16B. The second voltage sensor detects a voltage value of the voltage applied between the anode electrode 56 and the cathode electrode 58. The second current sensor detects a current value of the current flowing between the anode electrode 56 and the cathode electrode 58.

The sensors connected to the controller 22 include a plurality of pressure sensors. One of the pressure sensors is a first pressure sensor 62A provided on the oxygen supply passage 44. The oxygen supply passage 44 is a flow path outside the water electrolysis stack 12A that communicates with the anode electrode 36 of the water electrolysis stack 12A without the electrolyte membrane 34 being interposed. A first pressure sensor 62A is provided on the oxygen supply passage 44 between the pressure control valve 24 and the water electrolysis stack 12A. The first pressure sensor 62A detects the pressure of the gas (oxygen-containing gas) in the oxygen supply passage 44. The pressure detected by the first pressure sensor 62A is supplied to the controller 22.

One of the pressure sensors is a second pressure sensor 62B provided at the gas-liquid separator 14. The second pressure sensor 62B detects the pressure of the gas (hydrogen-containing gas) stored in the gas-liquid separator 14. The pressure detected by the second pressure sensor 62B is supplied to the controller 22.

The controller 22 includes one or more processors and a storage medium. The storage medium may be constituted by volatile and non-volatile memory. The processor may be a CPU, an MCU, etc. Examples of volatile memory include RAM. Examples of the non-volatile memory include ROM and flash memory. The processors execute computer-executable instructions to cause the controller 22 to control a plurality of devices. The devices includes a first power supply device 16A, a second power supply device 16B, a water supplier 18A, and a hydrogen supplier 18B.

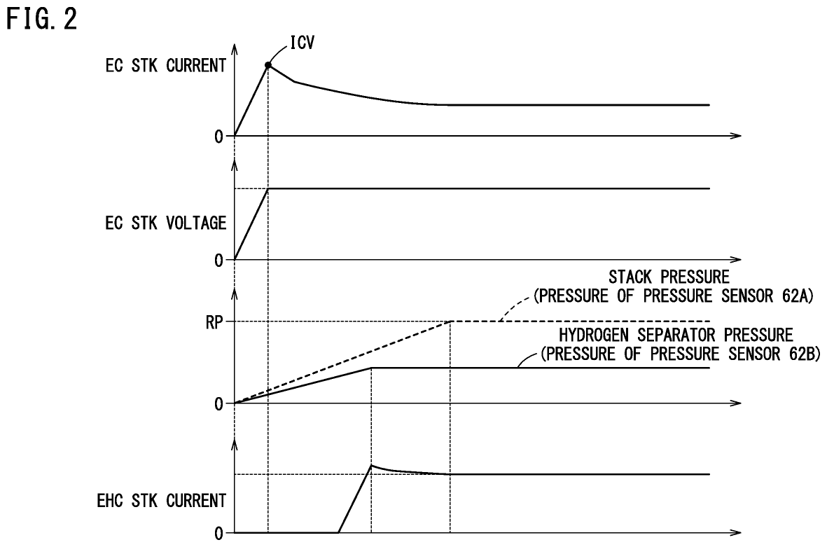

Next, the activation process of the controller 22 for activating the water electrolysis stack 12A and the hydrogen boost stack 12B will be described. FIG. 2 is a diagram showing a time chart concerning the activation process of the controller 22. The term “EC STK” in FIG. 2 corresponds to the water electrolysis stack 12A. Also, the term “EHC STK” in FIG. 2 corresponds to the hydrogen boost stack 12B. The term “stack pressure” in FIG. 2 corresponds to the pressure detected by the first pressure sensor 62A. In addition, the term “hydrogen separator pressure” in FIG. 2 corresponds to the pressure detected by the second pressure sensor 62B.

Upon receiving an activation instruction to activate the stack 12, the controller 22 controls the water supplier 18A to supply water from the gas-liquid separator 14 to the water electrolysis stack 12A via the water supply path 40. The water discharged from the water electrolysis stack 12A returns to the gas-liquid separator 14 via the water discharge path 42.

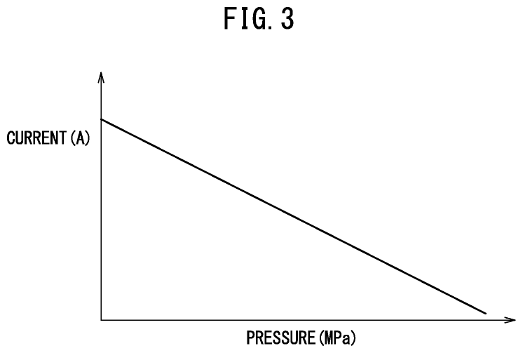

Thereafter, the controller 22 controls the first power supply device 16A. That is, the controller 22 acquires the pressure from the first pressure sensor 62A every time a unit time elapses, and acquires the current value corresponding to the pressure. In this case, the controller 22 acquires a smaller current value as the pressure detected by the first pressure sensor 62A is larger. The current value may be acquired based on data stored in the storage medium. The data stored in the storage medium is a database that defines current values corresponding to a plurality of pressure values, as shown in FIG. 3, for example. The current values corresponding to the multiple pressure values are defined in a manner so that the voltage applied by the power supply device 16 stays within a predetermined voltage adjustment range. In addition, current values corresponding to the multiple pressure values are defined in a manner so that the larger the pressure, the smaller the current value.

Upon acquiring the current value, the controller 22 specifies the current value for the first power supply device 16A. The first power supply device 16A controls the voltage applied to the anode electrode 36 and the cathode electrode 38, and causes the current having the current value specified by the controller 22 to flow between the anode electrode 36 and the cathode electrode 38.

While the water electrolysis stack 12A is stopped, no voltage is applied to the water electrolysis stack 12A by the first power supply device 16A. In this case, water electrolysis is not performed in the water electrolysis stack 12A, and therefore, the pressure in the oxygen supply passage 44 is comparable to the external pressure of the oxygen supply passage 44.

When the first current value (initial current value ICV) after receiving the activation instruction of the stack 12 is specified for the first power supply device 16A by the controller 22, the voltage and the current start to rise. When the voltage and the current start to rise, water electrolysis starts in the water electrolysis stack 12A, and oxygen gas is generated at the anode electrode 36. Therefore, as time passes, the pressure in the oxygen supply passage 44 gradually increases from the one comparable to the external atmospheric pressure. Therefore, the pressure (stack pressure) detected by the first pressure sensor 62A gradually increases. In FIG. 2, the initial pressure of the first pressure sensor 62A is illustrated as “0”. When the pressure in the oxygen supply passage 44 reaches a predetermined pressure RP set for the pressure control valve 24, the increase in pressure detected by the first pressure sensor 62A is generally stopped.

In this embodiment, the controller 22 changes the current value to be specified for the first power supply device 16A according to the pressure detected by the first pressure sensor 62A. Therefore, a large amount of current can flow between the anode electrode 36 and the cathode electrode 38 at an initial stage of the activation of the water electrolysis stack 12A that is in a state of having a large limiting current density. As a result, the amount (generation rate) of gas generated in the water electrolysis stack 12A can be increased without increasing an area of the electrode or the number of the membrane electrode assembly 32 (number of cells).

In the present embodiment, the controller 22 gradually reduces the current value from the initial current value (initial current value ICV) at which the activation instruction for the stack 12 was received, in accordance with the pressure detected by the first pressure sensor 62A. Therefore, a current value that approximates the limiting current density that varies with the gas pressure in the oxygen supply passage 44 can be specified for the first power supply device 16A.

In the present embodiment, the storage medium (storage unit) of the controller 22 stores data that specifies current values corresponding to a plurality of pressure values in a manner so that voltage falls within the predetermined voltage adjustment range. Based on the data, the controller 22 specifies a current value corresponding to the pressure detected by the first pressure sensor 62A for the first power supply device 16A. This allows the amount (generation rate) of gas generated in the water electrolysis stack 12A to be adjusted while the voltage applied between the anode electrode 36 and the cathode electrode 38 is generally kept constant.

In this embodiment, when a predetermined time has elapsed after the initial current value was specified for the first power supply device 16A, the controller 22 controls the hydrogen supplier 18B to supply hydrogen gas to the hydrogen boost stack 12B. Thereafter, the controller 22 controls the second power supply device 16B while also controlling the first power supply device 16A.

That is, every time the unit time elapses, the controller 22 acquires a current value to be specified for the second power supply device 16B based on the current flowing between the pair of electrodes of the water electrolysis stack 12A and the pressure detected by the second pressure sensor 62B provided at the gas-liquid separator 14. For example, the current detected by the current sensor of the water electrolysis stack 12A is assumed to be “A”. In addition, the number of cells of the hydrogen boost stack 12B is denoted by “B”, and the number of cells of the water electrolysis stack 12A is denoted by “C”. Further, an amount of operation for feedback control where the pressure detected by the second pressure sensor 62B follows the target pressure is denoted by “D”. In this case, the controller 22 may calculate “(A×B/C)+D” to acquire the current value to be specified for the second power supply device 16B.

Upon acquiring the current value, the controller 22 specifies the current value for the second power supply device 16B. The second power supply device 16B controls the voltage applied to the anode electrode 56 and the cathode electrode 58 and allows the current having the current value specified by the controller 22 to flow between the anode electrode 56 and the cathode electrode 58.

In this way, the controller 22 changes the current value to be specified for the second power supply device 16B based on the current flowing between the pair of electrodes of the water electrolysis stack 12A and the pressure detected by the second pressure sensor 62B provided at the gas-liquid separator 14. Therefore, the amount (generation rate) of gas generated in the hydrogen boost stack 12B can be specified while taking into account the amount (generation rate) of gas generated in the water electrolysis stack 12A and the amount of gas contained in the gas-liquid separator 14.

The above embodiment may be modified as follows. In the figures used in the following modified examples, the same reference numerals are assigned to the components equivalent to those described in the embodiments. In the following modified examples, the description overlapping with the embodiment will be omitted.

### Modified Example 1

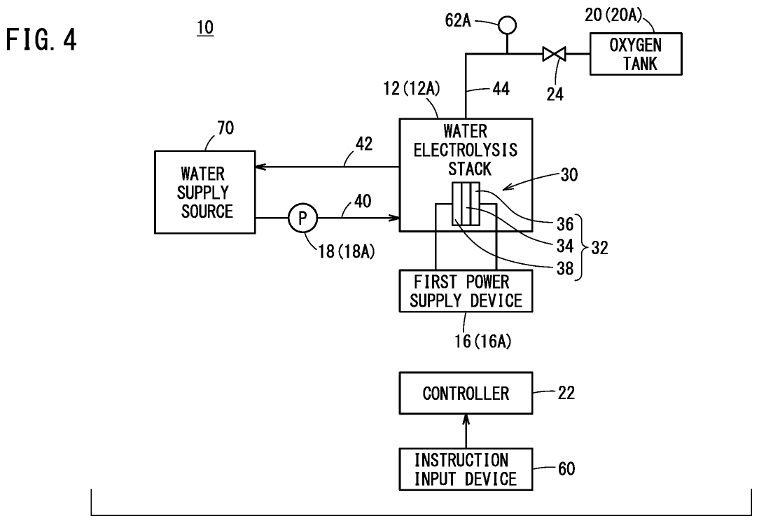

FIG. 4 is a schematic diagram showing the configuration of an electrolysis system 10 according to a modified example. The electrolysis system 10 of this modified example is not provided with the hydrogen boost stack 12B, the gas-liquid separator 14, the second power supply devices 16B, the hydrogen supplier 18B, or the hydrogen tank 20B. On the other hand, the electrolysis system 10 of this modified example is newly provided with a water supply source 70. The water supply source 70 supplies water to the stack 12 (water electrolysis stack 12A) via the water supply path 40. The water supply source 70 collects, via the water discharge path 42, water discharged from the stack 12.

In this modified example, the stack 12 may be an AEM water electrolysis stack or a PEM water electrolysis stack. When the stack 12 is an AEM water electrolysis stack, the stack 12 is provided with the membrane-electrode assembly 32 including the electrolyte membrane 34 that is an anion exchange membrane. On the other hand, when the stack 12 is a PEM water electrolysis stack, the stack 12 is provided with the membrane-electrode assembly 32 including the electrolyte membrane 34 that is a proton exchange membrane.

The controller 22 of the electrolysis system 10 according to the modified example 1 may control the power supply device 16 (first power supply device 16A) in the same manner as in the embodiment.

That is, the controller 22 acquires the pressure from the first pressure sensor 62A every time the unit time elapses, and acquires the current value corresponding to the pressure. The controller 22 also specifies a current value for the first power supply device 16A every time the unit time elapses.

With respect to the above disclosure, the following appendices are further disclosed.

### Appendix 1

The present disclosure is a controller (22) for controlling an electrolysis system (10) comprising: a water electrolysis stack (12A) that is provided with a membrane electrode assembly (32) including an electrolyte membrane (34) and a pair of electrodes (36, 38) that sandwich the electrolyte membrane, and electrolyzes water supplied to one of the pair of electrodes; a pressure control valve (24) that is provided on a flow path (44) through which oxygen gas acquired by the electrolysis flows and adjusts gas pressure in the flow path to a predetermined pressure (RP); and a first power supply device (16A) that applies voltage to the pair of electrodes in a manner so that current having a specified current value flows between the pair of electrodes, wherein the controller comprises one or more processors that execute computer-executable instructions, when receiving the instructions to activate the water electrolysis stack, the controller changes the current value specified for the first power supply device according to pressure detected by a first pressure sensor (62A) provided on the flow path between the pressure control valve and the water electrolysis stack.

This allows more current to flow between the pair of electrodes at the initial stage of the activation of the water electrolysis stack in a state where the limiting current density is large. As a result, the amount of gas generated (production rate) in the water electrolysis stack can be increased without increasing the electrode area or the number of membrane-electrode assembly (number of cells).

### Appendix 2

The present disclosure is the controller described in Appendix 1, wherein the controller may gradually reduce the current value from an initial current value at which the instructions to activate the water electrolysis stack is received. As a result, a current value that approximates the limiting current density that varies with the gas pressure in the flow path through which the oxygen gas flows is specified to the first power supply device.

### Appendix 3

The present disclosure is the controller according to Appendix 1 that may include a storage unit that stores data defining current values corresponding to a plurality of pressures in a manner so that the voltage falls within a predetermined voltage adjustment range, wherein the controller specifies the current value corresponding to the pressure detected by the first pressure sensor for the first power supply device based on the data. This allows the amount of gas generated (generation rate) in the water electrolysis stack to be regulated while the voltage applied to the pair of electrodes is kept generally constant.

### Appendix 4

The present disclosure is the controller according to Appendix 1, wherein the electrolysis system may further include a gas-liquid separator (14) that separates hydrogen-containing water supplied from the water electrolysis stack into hydrogen gas and liquid water supplied to the water electrolysis stack, a hydrogen boost stack (12B) that boosts the hydrogen gas supplied from the gas-liquid separator, and a second power supply device (16B) that applies a voltage to the hydrogen boost stack so that a current having the specified current value flows, and wherein the controller changes the current value specified for the second power supply device based on the current of the water electrolysis stack and the pressure detected by a second pressure sensor (62B) provided at the gas-liquid separator. Therefore, the amount of gas generated in the hydrogen boost stack (generation rate) can be regulated while the amount of gas generated in the water electrolysis stack (generation rate) and the amount of gas contained in the gas-liquid separator are taken into account.

### Appendix 5

The present disclosure is the controller according to Appendix 4, wherein the predetermined pressure may be set lower than a target pressure determined from an allowable water content in the gas. This can increase the gas boosting rate in the flow path.

The present invention is not limited to the above disclosure, and various configurations can be employed without departing from the gist of the present invention.

1. A controller for controlling an electrolysis system comprising:
a water electrolysis stack that is provided with a membrane electrode assembly including an electrolyte membrane and a pair of electrodes sandwiching the electrolyte membrane and that electrolyzes water supplied to one of the pair of electrodes;
a pressure control valve that is provided on a flow path through which oxygen gas acquired by the electrolysis flows and that adjusts gas pressure in the flow path to a predetermined pressure; and
a first power supply device that applies voltage to the pair of electrodes in a manner so that current having a specified current value flows between the pair of electrodes,
wherein
the controller comprises one or more processors that execute computer-executable instructions,
when receiving the instructions to activate the water electrolysis stack, the controller changes the current value specified for the first power supply device according to pressure detected by a first pressure sensor provided on the flow path between the pressure control valve and the water electrolysis stack.

2. The controller according to claim 1, wherein
the controller gradually reduces the current value from an initial current value at which the instructions to activate the water electrolysis stack is received.

3. The controller according to claim 1, further comprising a storage unit that stores data defining current values corresponding to a plurality of pressures in a manner so that the voltage falls within a predetermined voltage adjustment range,
wherein the controller specifies the current value corresponding to the pressure detected by the first pressure sensor for the first power supply device based on the data.

4. The controller according to claim 1, wherein
the electrolysis system further comprises:
a gas-liquid separator that separates hydrogen-containing water supplied from the water electrolysis stack into hydrogen gas and liquid water supplied to the water electrolysis stack;
a hydrogen boost stack that boosts the hydrogen gas supplied from the gas-liquid separator; and
a second power supply device that applies the voltage to the hydrogen boost stack in a manner so that the current having the specified current value flows, and
the controller changes the current value specified for the second power supply device based on the current of the water electrolysis stack and the pressure detected by a second pressure sensor provided at the gas-liquid separator.

5. The controller according to claim 1, wherein
the predetermined pressure is set lower than a target pressure determined from an allowable water content in the oxygen gas.
